(19) United States
(12) Patent Application Publication
(10) Pub. No.: US 2005/0254011 A1
(43) Pub. Date: Nov. 17, 2005

(54) Method for exhibiting motion picture films at a higher frame rate than that in which they were originally produced

(76) Inventor: Robert C. Weisgerber, New York, NY (US)

Correspondence Address: DAVID PETER ALAN, ESQ., 81 Second St, South Orange, NJ, 07079, US

(21) Appl. No.: 10/846,611

(22) Filed: May 17, 2004

(51) Int. Cl. G03B 41/00

(52) U.S. Cl. 352/84

(57) ABSTRACT

A method is disclosed for showing motion picture films at a frame rate higher than that in which the films were originally shot. This method uses computer software originally designed to generate cinematic images for a slow-motion effect to produce images for interpolation between each of the discrete images of an existing motion picture. The resulting film contains twice as many images as the film did when originally photographed, with a computer-generated “in between” image placed between each pair of successive images in the original film. These new transitional images simulate the appearance of motion that would have been captured by a camera, if twice as many discrete images had been photographed than actually were photographed in the original production. This method is especially suited to presentation of motion picture films on large theatrical screens. The method disclosed can be used for modification of films, by adding computer-generated images to only certain scenes or sequences of film action. This allows the effect created by this method to be added or removed at the discretion of the user of the method.

### BACKGROUND OF THE INVENTION

Most motion picture films produced for conventional theatrical exhibition are photographed at the speed of twenty-four frames per second, a frame rate that has been in use for most of the history of cinema. At that frame rate, there are undesirable artifacts that detract from the appearance of reality that is a goal of modern motion picture production. Films shot at that rate have flicker, perceptible grain, and an appearance of motion that does not seem smooth. This latter artifact is particularly objectionable on large theater screens (fifty feet or more in width), since any image component must move a greater physical distance between discrete images on a large screen than on a smaller screen.

Films shot at higher frame rates succeeded, to some extent, in suppressing this undesirable artifact. The original Todd-AO system from the 1950s utilized actual photography at thirty frames per second, in addition to the conventional twenty-four frames per second. A few motion pictures, including Oklahoma and Around the World in Eighty Days, were produced in that format. However, the use of separate photography at two different frame rates was costly, and few films were produced in the Todd-AO format. Later, the inventor herein taught a means for transitioning between film sequences photographed for exhibition at 24 and other sequences photographed at 30 frames per second between scenes of a single motion picture (U.S. Pat. No. 5,096,286(1992)). While there was a perceptible improvement in smoothness of motion at the higher frame rate, the latter system was never developed commercially.

More recently, Weisgerber has taught the use of forty-eight frames per second as a rate for photographing and showing motion pictures, to develop a presentation that suppresses the undesirable artifacts present at twenty-four frames per second (U.S. Pat. No. 5,627,614 (1997)). In that invention, certain sequences or certain image components were photographed at forty-eight frames per second, for a “high-impact” presentation. Other sequences or image components were photographed at twenty-four frames per second and double-frame printed, to retain the artifacts that gave the film the “cinematic” look. With the entire motion picture produced according to that invention projected at forty-eight frames per second, it became possible to give certain portions of a motion picture film or certain image components a more realistic look than other portions of the film or other image components. In order to deliver the full impact to the audience, the preferred embodiment of that invention used a large format, such as 70 mm format, eight perforations high, with images anamorphically squeezed onto the conventional 70 mm (five-perforation) format for storage on the film reel and stretched to the eight-perforation film format upon projection in the theater.

The previously-mentioned invention only works optimally in films produced according to it. This means that it only delivers the full audience effect in new films. For films already in existence, the full effect can only be delivered if those films are enhanced and converted for projection at a frame rate of forty-eight frames per second or higher. Most commercially produced films are photographed at twenty-four frames per second, including IMAX films. Most commercial films are still photographed in the 35 mm film format, which does not allow for sufficient visual information storage to deliver the full effect of the previous Weisgerber invention, which requires the 70 mm film format for the full desired effect. Most importantly, twenty-four discrete images each second are not enough to provide for the smooth appearance of motion delivered by the previous Weisgerber invention. Additional images must be added, and analog film methods also add undesirable amounts of blurring to transitional “in between” images created through image compositing.

Smoothness of motion, as seen by the audience, is especially important in modern motion picture theaters, where screens are normally fifty feet or more in width. Any motion projected onto the screen must cover a longer distance than on older screens, which were seldom over forty feet wide. In order for motion to appear smooth, extra images must be added between the original images of a motion picture film, so the large distances displaced by each image element from one image to another does not impart a jerky appearance to the film. The present invention solves this problem by using technology originally designed for a different purpose, as shall be shown.

### BRIEF DESCRIPTION OF THE INVENTION

The invention described here is a method for enhancing existing films, so that they can be shown according to the invention previously taught by Weisgerber. The invention uses the 70 mm film format, with five perforations per frame in the preferred embodiment. Since nearly all films that were ever commercially produced were photographed at twenty-four frames per second, the primary objective of the invention is to enhance films originally photographed at twenty-four frames per second, so that they can be projected at forty-eight frames per second.

This could not be done with analog film technology, but in can be accomplished using computerized techniques originally designed to produce additional film frames for a motion picture film, to create slow motion effects. In other words, when the maker of a film wishes the audience to view action apparently occurring in slow motion, he or she uses computer software to generate “extra” images to give the appearance that the action sequence takes longer to occur than would happen in reality. For example, a filmmaker wishes to make a sequence appear to take five seconds, when the action depicted in that sequence would actually take only one second to occur. The actual photography of the sequence in question requires twenty-four frames. To fill in the other ninety-six frames that will take up the other four seconds of viewing time, the filmmaker uses computerized techniques to create the other images, with a sequence of four images interpolated between each of the original twenty-four discrete images that were originally photographed for the sequence.

The present invention uses a similar technique for a different purpose. Films that have already been photographed and produced for public exhibition are first digitized by conventional means known in the art. Then computerized techniques are used to produce images for interpolation between each successive pair of original images. In this manner, the number of film images is doubled, so the resulting film can be projected at forty-eight frames per second, showing forty-eight discrete images every second. These films can be shown either through conventional projection, or through digital exhibition methods, as known in the art. For conventional projection, the films are converted back to analog “film” form.

The computerized techniques used in this invention impart the correct amount of motion blur to the films subjected to this enhancement and conversion method. Through this technique, films will appear as if they had originally been photographed at forty-eight frames per second. Films originally produced in the 35 mm format can also be converted to the 70 mm format by adding sufficient visual information to fully exploit the resolution available with the 70 mm film format. Moreover, computer-generated images can be added to only certain scenes in a film, while other scenes are double-frame printed, for projection at forty-eight frames per second. This allows the filmmaker to control whether or not the artifacts that deliver the “cinematic” look are actually suppressed in any specific scene of a motion picture. This is a feature of the film experience not available with conventional film methods, and only disclosed previously by Weisgerber for new films produced specifically to deliver this effect. Until the present invention, this effect was not available with any films that had previously been produced.

### BRIEF DESCRIPTION OF THE DRAWINGS

FIG. 1 shows five frames of motion picture film, lettered A through E. A vertical line is shown in each frame to illustrate movement of that line across the frame's field of view.

FIG. 2 shows nine frames; the five frames shown in FIG. 1, plus four other frames interpolated between them. Again, a vertical line is shown in each frame to illustrate movement of that line across the frame's field of view.

### DETAILED DESCRIPTION OF THE INVENTION

For conversion of existing motion picture films to be shown at a frame rate of forty-eight frames per second of higher, films are converted from analog to digital form by any means known in the conventional art. If a film destined for conversion was originally photographed for exhibition in the 35 mm format, sufficient picture information is also added to allow for reformatting onto the 70 mm film format without loss of picture quality.

Once the images are in digital form, a new image is generated for interpolation between each image of the original film and its successive image. These “in between” frames contain discrete images, generated by computer software originally designed for the purpose of generating extra images to create slow-motion effects when showing motion picture films. The extra images can be generated through the use of commercially-available software, used in the film and graphics industries. Cineon, developed by Eastman Kodak, and Retimer, developed by Reelviz, S. A., are suitable for this application.

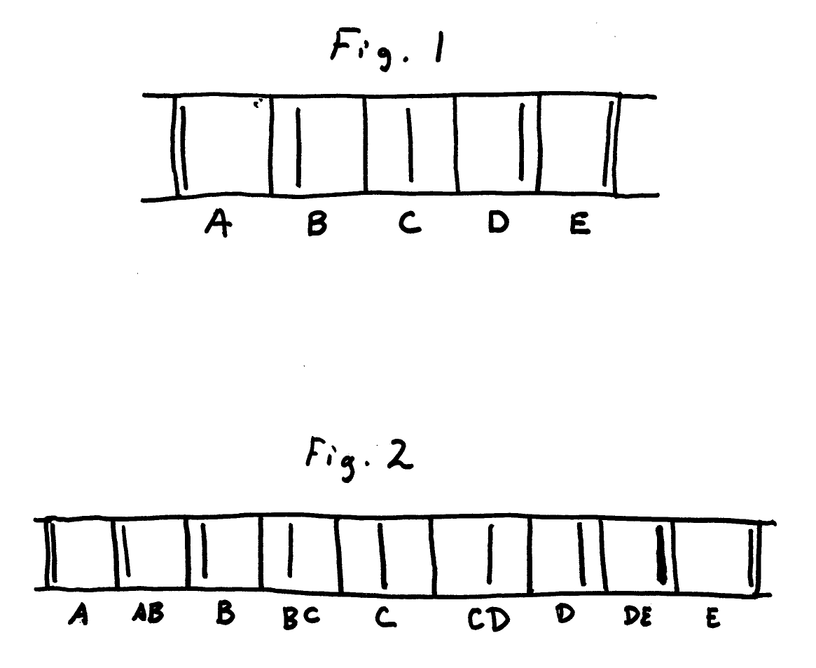

The effect of the interpolation of these synthesized images can be seen by referring to the drawings. FIG. 1 shows five frames of motion picture film, lettered A through E. These frames represent a short sequence of an existing motion picture film, of up to feature length. Instead of the live action that would typically be photographed, FIG. 1 shows a vertical line moving across the field of view represented by the frames in the drawing. In Frame A, the line is at the left side of the frame. It moves one quarter of the distance to the right at Frame B, one half of the distance to the right at Frame C, three quarters of the distance to the right at Frame D, and is located at the right side of the frame at Frame E. It should be noted that, the wider the screen onto which the film is projected, the greater the amount of distance placed between the position of the line from one frame to the next. This disparity of displacement causes objectionable stroboscopic effects when conventional motion picture films are projected at twenty-four frames per second onto large theatrical screens.

FIG. 2 shows the same film sequence, after enhancement according to this invention. The same five frames from FIG. 1 are shown, but there are now added four new images, one placed between each of the original frames. Images AB, BC, CD and DE are new computer-generated images, designed to appear as if they were discrete images, the way they would look if they were photographed at double the original frame rate of photography (typically forty-eight frames per second, instead of twenty-four). This process is repeated for the entire length of the motion picture film to be converted for exhibition. It should be noted that the position of the vertical line has moved only half the distance between images, compared to the smaller number of frames in FIG. 1. This reduced disparity of displacement from one image to the next cuts down significantly on the undesirable stroboscopic effects inherent in projection at conventional frame rates onto large theatrical screens.

The resulting “film” in digital form is then either projected digitally according to methods known in the art, or it is converted back to analog “film” format for conventional projection. In the preferred embodiment of the invention, the 70 mm film format is used, with eight perforations per frame. This creates a taller image and one with a more “square” aspect ratio than the 2.21 to 1 that is normally found in the 70 mm format with five perforations per frame. The films prepared for exhibition according to this invention can be stored on 70 mm film in the five-perforation format. The aspect ratio can be changed by anamorphic expansion upon projection.

In the present invention, exhibition is similar to that taught by Weisgerber in U.S. Pat No. 5,794,839 (1997). Projection is at forty-eight frames per second, and the present invention allows forty-eight discrete images to be delivered to the audience every second during the entire film presentation.

The invention described delivers enhanced versions of films produced in the 35 mm format by augmenting the information packing density associated with the 35 mm format, to the level associated with the 70 mm film format. In effect, the method described here adds more information packing density to existing films, so the audience will perceive more visual information than was placed onto the original film in the original production. While it is envisioned that the invention described will be used primarily with motion pictures produced through film methods known in the art, invention described is also suitable for conversion of motion pictures produced through 24P digital production acquisition, with its information storage capability of 1080×1920 pixels.

By using digital enhancement methods and computerized image creation to add sufficient information to each image to accommodate the 70 mm format, as well as to generate new images to fit between each of the previously-photographed images, conversion can be accomplished efficiently, without losses of light, image clarity or resolution associated with optical conversion methods. The method described reduces grain and improves apparent resolution, resulting in a “value added” presentation, which delivers the image clarity associated with large film formats, photographed originally at frame rates higher than the conventional twenty-four frames per second.

Another collateral benefit of this invention is that the dynamic image enhancement described also reduces grain, sharpens images and produces an image with a superior appearance on large theatrical screens, compared to those available through conventional means. With conventional film technology, there is more objectionable grain and lower apparent resolution than with the present invention.

Digitizing the film images before engaging in the enhancement process improves the impact of a theatrical motion picture presentation without sacrificing picture quality. This reduction of picture quality is inherent in optical enlargement of films originally produced in the 35 mm film format and converted to the 70 mm film format. In effect, the change in formats is done much more efficiently with digitized images than with conventional film images. In addition, the impartation of “transitional” images between each of the original images is only available through use of the invention described here.

While the basic invention and the preferred embodiment have been described, this description should be thought of as illustrative and not limiting. Other frame rates, such as fifty or sixty frames per second, can be used. So can other film formats. Other embodiments are also possible, and they should be thought of as lying within the scope of the invention.

1. A method for converting previously-produced motion picture films for projection at a higher frame rate than that in which such films were originally produced, to motion picture theater audiences, with the effect of improving the presentation of such films to the members of such audiences, the method comprising: the conversion of each of the images in the film selected for conversion to a digital format; the formulation of images which appear to depict the scene of the motion picture at an interval half way between the appearance of one such image and the next successive image in said motion picture film; the interpolation of these transitional images between each image of the original motion picture film and its successive image; the conversion of the motion picture to a film or digital form suitable for projection; and the projection of such film at double the frame rate at which said film was originally produced.

2. The method as in claim 1, in which said transitional images are generated using computerized imaging techniques.

3. The method as in claim 2, in which said transitional images are generating using Cineon or Retimer software.

4. The method as in claim 1, in which films originally produced for projection at twenty-four frames per second are converted according to the method described for projection at forty-eight frames per second.

5. The method as in claim 1, in which films converted according to the method described are exhibited to audiences in the 70 mm film format.

6. A method for converting previously-produced motion picture films for exhibition to audiences for delivery of heightened impact upon the members of said audiences, where the improvement comprises the use of computerized image-generating techniques to produce transitional images, the impartation of such images between each image of the original motion picture film and its successive image, and projection of the entire motion picture at double the frame rate at which the original motion picture was designed to be exhibited.
